(19) United States
(12) Patent Application Publication
(10) Pub. No.: US 2019/0177099 A1
(43) Pub. Date: Jun. 13, 2019

(54) LOADING DOCK SEAL

(71) Applicant: NOVA TECHNOLOGY INTERNATIONAL, LLC, Menomonee Falls, WI (US)

(72) Inventor: Robert J. Hensel, Germantown, WI (US)

(73) Assignee: NOVA TECHNOLOGY INTERNATIONAL, LLC, Menomonee Falls, WI (US)

(21) Appl. No.: 16/213,670

(22) Filed: Dec. 7, 2018

Related U.S. Application Data
(60) Provisional application No. 62/596,238, filed on Dec. 8, 2017.

(51) Int. Cl. B65G 69/00; G07C 3/04; H04W 4/44

(52) U.S. Cl. CPC B65G 69/008; H04W 4/44; G07C 3/04

(57) ABSTRACT

A system and method for gathering information from a loading dock seal, the system including a loading dock having a loading dock seal and at least one sensor located proximate to the loading dock seal. The system further includes a counter reader which may be either an externally located dedicated counter or an Internet of Things Platform.

### RELATED APPLICATIONS

This application claims the benefit of provisional application Ser. No. 62/596,238 filed 8 Dec. 2017.

### BACKGROUND OF THE INVENTION

The present invention pertains to loading docks, particularly loading docks commonly found on commercial or industrial buildings and warehouses for use by trucks for loading and unloading transported items. A typical loading dock includes several components including a seal member. The seal member creates a seal between a transport vehicle (such as a truck or trailer) and the building on which the loading dock is located. Most loading dock seals share common attributes although there are several variants. The usual and customary method of constructing a loading dock seal consists of securing a large piece of foam to a backer mount (wood or steel backers are common), fully wrapped in vinyl or another fabric which can withstand the operating environment.

In use, a truck/trailer backs into the loading dock, and compresses the seal between the truck/trailer and the building wall, to thereby create a seal that prevents foreign material (dust, rain, air, etc.) from entering or leaving the building. During loading and unloading, as a forklift or other transport vehicle passes from the loading dock into the trailer (or vice versa) the trailer typically moves up and down, with the back of the trailer sliding against the stationary seal, causing wear of the fabric. Eventually this wear causes the fabric to wear through, tear, or in cases where it maintains integrity, it may become dirty and frayed. The seal must then be repaired or replaced for optimal performance. Typically, the decision to repair or replace a worn seal is made by observation of the loading dock users. The user then must contact a seal provider or seal repair provider to put the dock back into service. Typically, replacement is required. Thus, known seals are put into service at a loading dock and used until they wear out or are damaged to the point at which they don't function properly, and need to be replaced in their entirety rather than having the worn portions replaced. This takes time, causing the dock to be unusable for service, and may be costly when a full replacement is necessary. Thus there exists a need for an automated use meter, wherein metrics concerning use and wear are measured and transmitted to a provider, to communicate the need for repair prior to failure and need for total replacement. Moreover, a use meter may further predict when replacement is needed to thereby reduce dock downtime, since replacement may be coordinated with other planned downtime or allow full coordination of replacement parts prior to actual part failure.

### SUMMARY OF THE INVENTION

The present invention is directed to a system and method for monitoring and measuring docking events of a loading dock seal. The system includes a loading dock seal having at least one monitoring device, such as a sensor, and a counting device. The sensors, or other monitoring devices measure predetermined metrics, for which the cycles of use and degree of wear of the loading dock seal may be detected locally, communicated with a cloud platform and then monitored remotely, thus enabling coordination of service or replacement of the loading dock seal without disturbing the end-user. Alternatively, the sensor may connect to an externally mounted counting device rather than a cloud platform. The invention envisions use of sensors or other monitoring devices to detect loading dock events such detecting motion and/or air pressure, temperature, and/or humidity, by way of non-limiting examples. The invention further contemplates a solution for computing service, engineering, and manufacturing activities through the use of loading dock event metrics.

### BRIEF DESCRIPTION OF THE DRAWINGS

FIG. 1 is a perspective view of a vehicle nearing a loading dock seal.

FIG. 1A is an enlarged side view of a portion of FIG. 1 and showing the loading dock seal in non-compressed state and extending away from the wall a distance greater than the bumper.

FIG. 2 is a view similar to that of FIG. 1, but showing the vehicle backed into the loading dock seal and the seal compressed.

FIG. 2A is a view similar to that of FIG. 1A, but showing the loading dock seal in compressed condition and extending away from the wall a distance similar to the bumper.

FIG. 3 is a view of a loading dock seal according to the present invention with a partial cut away, and showing component parts.

FIG. 4 is a schematic view showing sensors on the loading dock seal with sensors interfacing with an Internet of Things and transmitted to an end user.

FIG. 4A is a view similar to that of FIG. 4, but illustrating the system having an external counter reader.

FIG. 4B is a view similar to that of FIGS. 4 and 4A, but illustrating the system having an external counter reader and external sensors.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention which, is defined by the claims.

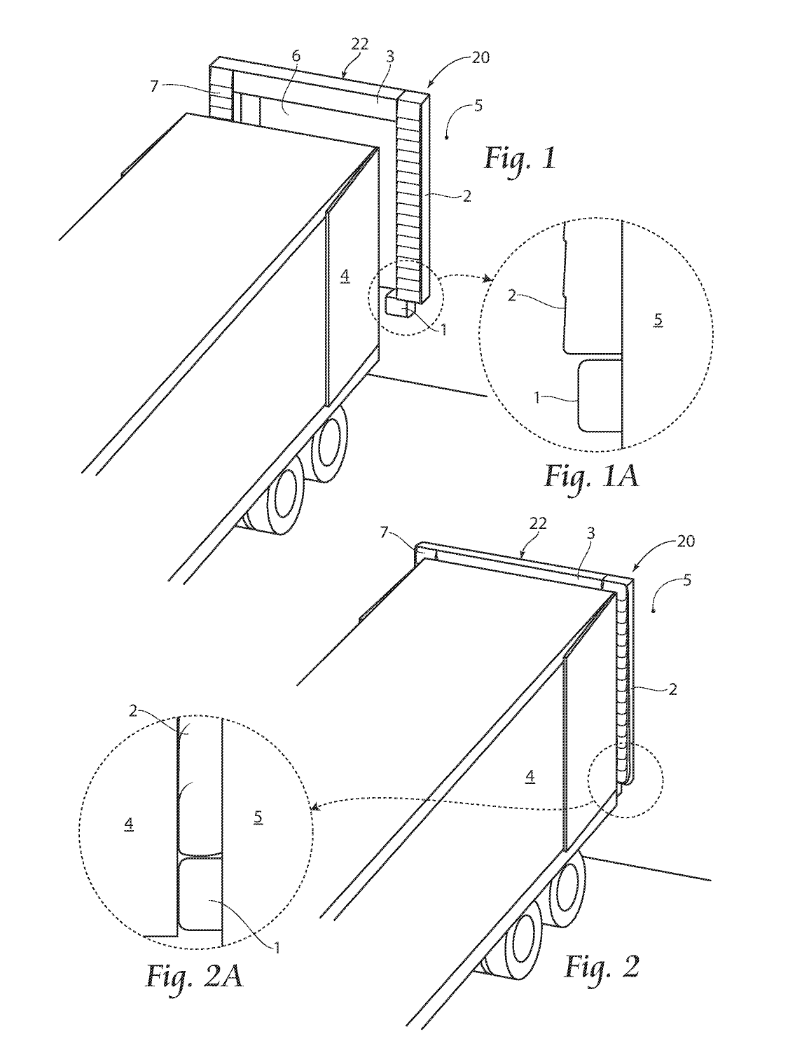

With attention to the Figures, a loading dock 20 having a seal 22 and at least one sensor 11 may be seen. As shown in FIG. 1, with no transport vehicle 4 at the loading dock 20, the dock seal 22 is at a resting position. FIG. 1 shows a Foam Pad (FP) compression-type seal 22 surrounding a loading dock door opening 6, and mounted on a building wall 5. While an FP type seal 22 is shown in these views, it is to be understood that other types of seals may be utilized with the present invention and method, as will be discussed. The FP seal 22 of these views includes a right side pad 2, a left side pad 7, and a head pad 3. As seen particularly in the view of FIG. 1A, the seal 22 projects outwardly from the building wall 5 at a distance greater than the bumper 1. As mentioned other loading dock seals 22 may be used with the present system without departing from the invention. For example, while not specifically shown in the Figures, a non-limiting list of seal examples includes:

Foam Pad (FP) seal having side pads 2, 7 and head pad 3 constructed of vinyl-wrapped foam mounted on a backer. The vehicle 4 backs into and compresses the foam to create a seal.

Foam Pad with Hood (FPH) seal having side pads 2, 7 of vinyl-wrapped foam with a head portion 3 being a vinyl hood. The vehicle 4 compresses the side pads 2, 7, while the hood is in sliding contact with the roof of the vehicle 4 to create a seal.

Foam side pads having an L-shaped cross section (FPU) including a foam-filled “curtain” that wipes against the side of the vehicle 4 to create a seal. This allows full access to the rear of the vehicle 4 while the top of the vehicle 4 compresses a foam-filled head pad 3.

Foam side pads having an L-shaped cross section (FPHU). Similar to FHU, but instead of a foam-filled head pad 3, the seal includes a hood which is arranged for sliding contact with the vehicle 4 roof.

A Rigid Frame Shelter (RF) includes rigid frames sides mounted to a building wall 5, with fabric side curtains arranged for sliding contact with the vehicle 4 sides to create a seal. A fabric head curtain contacts vehicle 4 roof to make a seal.

A Soft Sided Shelter (SS). Similar to the RF Shelter, but with vinyl-wrapped foam side frames which compress. This reduces damage when a vehicle 4 backs in off-center.

A Gap Sealing Shelter (GS). Similar to SS, but having a semi-rigid full-length hook extrusion which are arranged to capture the rear sides of a vehicle 4 having a rear swinging door. The arrangement reduces airflow through the gap created by door hinges.

A Flex Frame (FF) is similar to the RF Shelter, having mechanically flexible side frames. The arrangement reduces damage when a vehicle 4 backs in off-center.

An inflatable Shelter (IS) includes vinyl-wrapped seals inflated with air pressure rather than foam to compress to form a seal between the vehicle 4 and building wall 5. The IS type is often used at railcar docks as well as truck docks.

Other loading dock seal 22 styles may be envisioned, but the system and method described herein may be utilized with all types of loading docks and seals. Operating results are similar regardless of the specific loading dock seal 22 used because when a vehicle 4 makes contact with the seal 22, relative motion between the vehicle 4 and the seal 22 causes wear and tear.

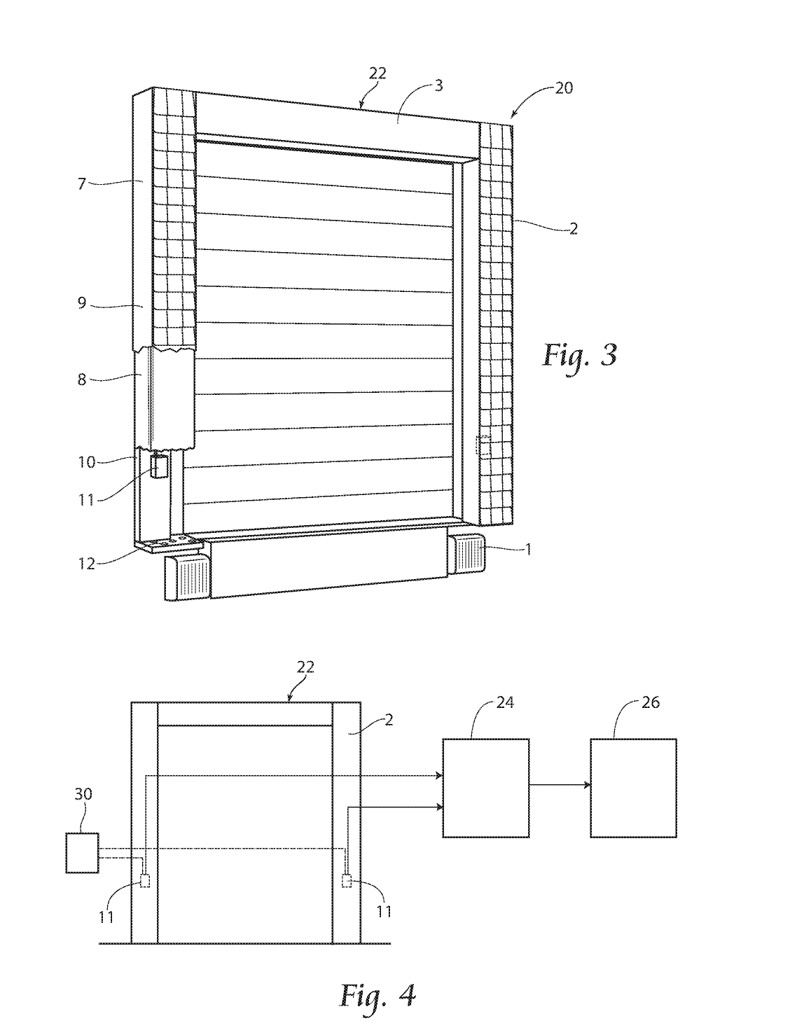

As further shown in FIGS. 1 and 2, a vehicle 4 backs to the loading dock 20 and travels until it rests against the loading dock 20 bumpers 1. Initially, the dock seal pads 2, 3, 7, project out from the wall 5 at a greater distance than the bumper 1. Once in docking position, and as seen in FIG. 2A, the seal pads 2, 3, 7 are compressed to a projection roughly equal to the bumper 1 projection. While the seal pads 2, 3, 7 are compressed, the pressure within the seal pads 2, 3, 7 rises slightly until air entrapped within the fabric-covered pad 2, 3, 7 escapes through the grommets 12 or other openings (see FIG. 3). Once the trapped air has escaped, the seal pads 2, 3, 7 normalize at the local ambient barometric pressure.

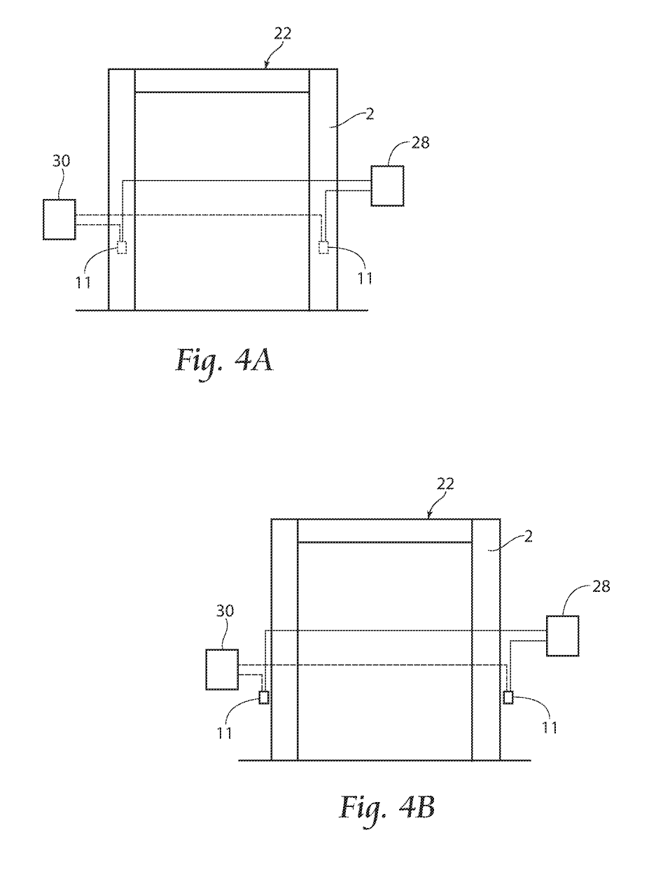

The present system includes a loading dock seal 22 and at least one sensor 11 on the loading dock seal 22. The system further includes a counter reader 28, or other means for gathering information collected by the sensor 11. The sensors 11 allow the end user to monitor certain predetermined conditions of the seal 22, such as cycles of use, wear, and the like. One example of a sensors 11 for use with the present system may include those used to monitor displacement of the dock seal 22 working surfaces 2, 3, 7. Other information such as ambient pressure, humidity, and/or temperature may be registered and monitored if desired. It is to be understood that while sensors 11 mounted on the seal 22 are illustrated, it is within the scope of the invention to include other devices for monitoring docking events, including those mounted externally, as seen in FIG. 4B. Further, it is to be understood that any sensor 11 able to gather the docking or undocking event external to the seal 22 may be utilized by the present invention. Examples include, but are not limited to, photoelectric sensors, mechanical displacement clickers, or motion sensors mounted externally to count docking events (see FIG. 4B).

As shown in FIGS. 2 and 4, a vehicle 4 backs into the seal 22, and a sensor 11 records the docking event. The information measured by the sensor 11 may be transmitted to an Internet of Things (IoT) Platform 24 via Wi-Fi, cellular communication, or other acceptable means. The Internet of Things (IoT) platform 24 stores and utilizes the gathered information. The gathered information corresponds to the predetermined conditions selected by the user and the sensor 11 used on a particular seal 22. Alternatively, and as seen in FIGS. 4A, 4B, the sensor 11 may not transmit to an Internet of Things (IoT) Platform 24, rather a sensor 11 may comprise a mechanical clicker or counter, such as those commercially available from electronics and instrumentation supply houses, and the information is gathered by, for example, a counter reader 28. As mentioned, various sensors 11 may be employed by the present system and may vary according to the desired data to be collected. Non-limiting types of sensors to be used on a selected dock seal 22 or shelter include those used to measure or count pressure, humidity, temperature, or displacement.

It is to be understood that while an ultrasonic distance sensor 11 is illustrated herein, any sensor 11 able to gather information pertaining to predetermined conditions selected by the user may be utilized by the present system and method. For example proximity sensors or pressure sensors, as will be discussed. Moreover, it is envisioned that multiple sensors 11 may be utilized by a single loading dock 20, depending on the needs of the user. Several downstream uses of the information gathered by the sensor 11 may be utilized. Non-limiting examples of such uses include:
Invoicing of customer for seal based on a “per use” fee rather than up-front expenditure.
Reporting to end user whether there is a vehicle at the specific loading dock.
Monitoring wear and tear of the seal based on usage. May lead to better product design.
Predicting when service and replacement is needed based on known usage levels and wear-out rates. Enabling a predictable production schedule for replacement products.
Allowing the manufacturer to level load production schedules during slow periods with planned replacements.
For the distributor, providing predictable repeat business, enabling scheduling service calls aligned with when the product needs service.
   The information gathered by the system provides the original equipment manufacturer (OEM), distributor, and end customer with an understanding of the customer base and assets associated with each.

As mentioned, and with attention to FIG. 4, the sensor 11 is preferably connected to an Internet of Things (IoT) 24 platform with the gathered information transmitted via Wi-Fi, cellular (or other means which may be developed from time to time), to provide the gathered information to the user 26. The user 26 may utilize the information in ways previously mentioned, for example to provide a new sales model such as a subscription-based selling of dock seals to lower costs for end user, or to enhance repeat business for the OEM and distributor whereby the end user has reduced costs over time. Another aspect of the system and method is the development of business logic, business rules and notifications that deliver directed activities/work to the parties, for example, OEM, distributor, or end customer. In addition, cycles of use may be counted, the information transmitted to the OEM, and compiled by the OEM to proactively produce replacement seal covers for installation by the distributor. This enables prediction of seal life, and when combined with a subscription-based sales model, allows repair/replacement of seals prior to wear-out and at a lower cost than traditional methods.

The present system provides lower expenses to the end user 26 over the course of time compared to the cost of traditional seal replacements. The system and method further ensures that loading dock seals 22 are in operating condition due to regularly scheduled replacement in response to information gathered by the sensor 11 regarding cycles of use. This results in optimal loading dock 20 usability. The manufacturer benefits from repeat business and is able to plan production accordingly, thereby enabling higher efficiency use of resources. The distributor benefits from repeat business and is able to plan service calls well in advance.

By way of non-limiting example, when the sensor 11 used is an ultrasonic distance sensor, the sensor 11 monitors a change in seal compression between the seal 22 at rest and the seal 22 when compressed (see FIGS. 1A and 2A). The sensor 11 records the change as a cycle of operation indicating the presence of a vehicle 4 at the loading dock 20 door. Later, when the vehicle 4 departs, the dock seal 22 expands to its original dimension. During this expansion, the pad 2, 3, 7 stabilizes to its original shape and size. When the sensor 11 to be used is a pressure sensor, the pressure drop and stabilization back to ambient pressure of the pad 2, 3, 7 is monitored. A pressure drop indicates that a vehicle 4 has departed the loading dock 20.

With attention to FIG. 3, typical seal 22 construction may be seen. An FP seal 22 is shown as including a wood or metal frame backer 10, with a foam pad 8 attached to it, and wrapped with fabric 9 which is attached to the backer 10. Grommets 12 or other openings in the pad 8 allow air and water to escape the pad 8. As shown, a sensor 11 may be mounted on the backing board 10. In this configuration the side pads 2, 7 and head pad 3 are constructed of vinyl-wrapped foam mounted on a backer 10, into which a vehicle 4 backs. When backed into, the foam pad 8 compresses to create a seal. Other examples of seals 22 have been previously described, including FPH (not shown), and it is to be understood that the FP seal 22 is illustrated by way of non-limiting example. As shown in FIG. 3, the FP seal 22 includes vinyl-wrapped foam side pads 2, 7 and a head portion 3 being a vinyl hood.

It is to be understood that there are various types and grades of fabric used in the construction of loading dock seals. In this document they are referred to as “vinyl” because that is most common, but other fabrics are also used and are to be included herein. Likewise, here are many grades and weights of vinyl used in the construction of loading dock seals, all of which are included in the description of “vinyl”. Lower grades and lighter weights of vinyl (such as 22 ounce) tend to wear out faster than heavier weights (such as 40 ounce). Additionally, some loading dock seals are outfitted with protective layers of fabric in a variety of styles, including single-layer known as scuff guard, or multiple layers cascading from top to bottom of side pads or head pads or hoods, typically known as wear pleats. These protective layers tend to extend the wear-out process, providing longer seal life.

With attention to FIGS. 4, 4A, and 4B it may be seen that a system according to the present invention may include a power source 30. For example, when the sensors 11 communicate with an IfT platform 24 (see FIG. 4), the sensors 11 may be battery charged through solar power. Alternatively, the power source 30 may include a rechargeable battery, wired connection to dock building 5 (see FIGS. 4A, 4B), or any other acceptable source.

The present invention includes a method of gathering information from a loading dock seal 22 including the steps of:

providing a loading dock 20;

providing said loading dock 20 with a loading dock seal 22;

providing said loading dock seal 22 with at least one sensor 11;

moving said loading dock seal 22 to a compressed position, said sensor 11 detecting said compressed position as information; and

transmitting said information to a counter reader, wherein said counter reader may be an externally mounted dedicated device 28, or an IoT Platform 24.

The present invention is a system for gathering information from a loading dock seal 22 including: a loading dock 20; a loading dock seal 22 located on said loading dock 20; at least one sensor 11 proximate to said loading dock seal 22; and a counter reader. The counter reader for the system may be an externally mounted dedicated device 28, or an Internet of Things Platform 24.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A method of gathering information from a loading dock seal including the steps of:
providing a loading dock;
providing said loading dock with a loading dock seal;
providing said loading dock seal with at least one sensor;
moving said loading dock seal to a compressed position, said sensor detecting said compressed position as information; and
transmitting said information to a counter reader.

2. The method of claim 1 wherein said counter reader is an Internet of Things Platform.

3. A system for gathering information from a loading dock seal including:
a loading dock;
a loading dock seal located on said loading dock;
at least one sensor proximate to said loading dock seal; and
a counter reader.

4. The system of claim 3, wherein said counter reader is an externally mounted dedicated device.

5. The system of claim 3, wherein said counter reader is an Internet of Things Platform.
